(19) United States
(12) Patent Application Publication
(10) Pub. No.: US 2006/0275657 A1
(43) Pub. Date: Dec. 7, 2006

(54) Sealed rechargeable battery and manufacturing method of the same

(76) Inventors: Kiyomi Kozuki, Osaka (JP); Tatsuya Hashimoto, Ishikawa (JP); Koki Inoue, Osaka (JP); Yasushi Hirakawa, Osaka (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/434,522

(22) Filed: May 16, 2006

(30) Foreign Application Priority Data
May 16, 2005 (JP) 2005-142643
Apr. 25, 2006 (JP) 2006-120967

(51) Int. Cl. H01M 2/08; H01M 2/12; H01M 10/04

(52) U.S. Cl. 429/185; 429/86; 29/623.2; 29/623.4

(57) ABSTRACT

A sealed rechargeable battery containing an electrode unit and a liquid electrolyte in a metallic case with a bottom that is sealed with a closure assembly. The electrode unit includes a positive electrode and a negative electrode, each made up of a collector and electrode material paste coated thereon, wound around with a separator interposed therebetween. The closure assembly includes a metallic filter that forms an internal terminal and accommodates a safety mechanism provided in case of abnormal pressure rise caused by overcharging etc, a resin inner gasket, and a metallic cap that forms an external terminal superposed upon one another. A resin inner gasket is attached to the metallic filter and the end edge of the metallic filter is crimped to provide a seal. The metallic filter and all the metallic parts encased in the metallic filter are joined together by welding. This closure assembly design enables high power output and high-current discharge of the battery with low resistance.

The present disclosure relates to subject matter contained in priority Japanese Patent Applications No. 2005-142643, filed on May 16, 2005, and No. 2006-120967, filed on Apr. 25, 2006, the contents of which is herein expressly incorporated by reference in its entirety.

### BACKGROUND OF THE INVENTION

1. Field of the Invention

The present invention relates to a sealed rechargeable battery suitable for use as a driving power source, and more particularly to its closure assembly design with low resistance suitable for high-current discharge, and the manufacturing method of the battery.

2. Description of the Related Art

Sealed rechargeable batteries, and particularly lithium ion rechargeable batteries, are small, lightweight, and high in energy density, and therefore used for various purposes ranging from consumer electronic equipment such as mobile phones to driving power sources of electric vehicles or electric tools. It is considered particularly suitable for use as driving power sources, and research has been intensified on measures for increasing the energy density and output power of the battery. FIG. 4 shows the closure assembly design of a lithium ion rechargeable battery commonly used in consumer electronic equipment. A metallic filter 19, which serves as an internal terminal of the battery, accommodates a metallic foil 20, a resin inner gasket 21, a metallic safety vent 22, and a metallic cap 23 that serves as an external terminal, placed in this order. The end edge of the metallic filter 19 is crimped with the inner gasket 21 to provide a seal. The metallic foil 20 and the safety vent 22 are joined at a weld joint S at the center part thereof and electrically connected to each other. When the internal pressure of the battery rises abnormally by accidental overcharging, a thin portion 20a of the metallic foil 20 breaks and cuts the current path to restrict generation of gas inside the battery, and if the internal pressure does not stop rising due to some fault, then the safety vent 22 is activated, i.e., its thin part 22a breaks, to release gas to the outside. Between the battery case and the closure assembly is interposed an outer gasket 25.

The closure assembly of nickel metal hydride or nickel cadmium rechargeable batteries and lithium ion rechargeable batteries for automobiles which require high output has the following improved design: The metallic filter serving as the internal terminal accommodates a metallic safety vent or rubber vent and a metallic cap serving as the external terminal placed upon the vent, with a rubber ring between the vent and cap for providing a seal. The end edge of the metallic filter is crimped to establish electrical connection, and the filter and the cap are joined by welding to reduce resistance (see, for example, Japanese Patent Publication No. 2000-90892). Such closure assembly design is known to reduce resistance in the assembly and is suitable for the above mentioned high power batteries which are discharged at a high current or batteries that need to be connected in series.

In another design disclosed, for example, in Japanese Patent Publication No. 2001-126695, part of a safety vent component is joined to the outer periphery of a metallic cap by welding, as measures for restricting any increase or variation in internal resistance and for enabling efficient high-current discharge despite possible changes over time or temperature changes.

These closure assemblies of lithium ion rechargeable batteries used in consumer electronic equipment generally employ molded synthetic resin inner gaskets that are set inside and crimp sealed with the metallic filter. However, synthetic resin such as polypropylene loses its resiliency over time during which it may be dropped, vibrated, or stored at high temperature, because of which the crimp strength decreases and contact resistance of internal parts increases.

The closure assembly design shown in Japanese Patent Publication No. 2000-90892 does not include a metallic foil. In case of accidental overcharging of the battery, rapid decomposition of liquid electrolyte and active materials will be accelerated if the current path is not interrupted, which may lead to a gas burst from the battery caused by a temperature rise inside.

The closure assembly design shown in Japanese Patent Publication No. 2001-126695 relies largely on the mechanical crimping to join most parts of the components, although part of the safety vent and the cap are welded together. Therefore, the crimp strength decreases over time during which the battery may be dropped, vibrated, or stored at high temperature, and contact resistance of internal parts increases, resulting in an increase in internal resistance of the battery.

### BRIEF SUMMARY OF THE INVENTION

In view of the problems in the conventional techniques, object of the present invention is to provide a sealed rechargeable battery using a closure assembly with high safety features suitable for high power output, a closure assembly that inhibits an increase in resistance caused by a fall, vibration, temperature changes that may occur over time, and that ensures stable output characteristics of the battery.

To achieve the above object, the present invention provides a sealed rechargeable battery including an electrode unit and a liquid electrolyte encased in a metallic case with a bottom, and a closure assembly attached to the case by crimping the case end with a resin outer gasket interposed therebetween. The electrode unit includes a positive electrode and a negative electrode wound around with a separator interposed therebetween. In this configuration, metallic parts that make up the closure assembly are all joined together by welding.

By joining all the metal parts making up the closure assembly by welding, the above object of providing a high power battery with low internal resistance and high safety features is achieved.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a schematic longitudinal cross-sectional view showing a cylindrical lithium ion battery according to one embodiment of the present invention;

FIG. 2 is a cross-sectional view showing a closure assembly design of the sealed rechargeable battery of the invention;

FIG. 3 is a cross-sectional view showing another closure assembly design of the battery; and

FIG. 4 is a cross-sectional view showing a closure assembly design of a conventional sealed rechargeable battery.

### DESCRIPTION OF THE PREFERRED EMBODIMENTS

A sealed rechargeable battery and its manufacturing method of the invention will be hereinafter described with reference to FIG. 1 to FIG. 3. The following description is given for illustrating examples of embodiment of the invention and is not intended to limit the technical scope of the invention.

The sealed rechargeable battery of the invention includes an electrode unit and a liquid electrolyte encased in a metallic case with a bottom, and a closure assembly attached to the case by crimping the case end with a resin outer gasket interposed therebetween. The electrode unit includes a positive electrode and a negative electrode wound around with a separator interposed therebetween. The metallic parts that make up the closure assembly are all joined together by welding. This feature enables a high power battery design with much reduced internal resistance.

The closure assembly includes a metallic filter, which accommodates a safety mechanism consisting of a metallic safety vent and a metallic foil, the resin inner gasket, and a metallic cap. The metallic filter and all the metallic parts accommodated in the metallic filter are joined together by welding. This enables realization of a high power rechargeable battery with low internal resistance and high safety features.

The metallic cap and the metallic safety vent, and the metallic filter and the metallic foil, are respectively joined at four or more circumferentially equally located welds in the periphery, and the metallic safety vent and the metallic foil are welded together at the center. This design further ensures low internal resistance of the sealed rechargeable battery, and helps realize a high power rechargeable battery with low internal resistance and high safety features.

The resistance between the metallic cap and the metallic filter should preferably be in the range of 0.01 to 0.5 mΩ, which further ensures low internal resistance of the battery, and helps realize a high power rechargeable battery with low internal resistance and high safety features.

A disc-like metallic spacer may be interposed between the metallic safety vent and the metallic cap inside the metallic filter. This further ensures high safety of the high power battery.

The present invention also provides a method for producing a high power sealed rechargeable battery with low internal resistance and high safety features, the method including the following process steps of: joining a metallic cap and a metallic safety vent by welding; joining a metallic filter having an aperture and a metallic foil by welding; crimping an end edge of the metallic filter after placing a resin inner gasket and the joined metallic cap and the metallic safety vent onto the joined metallic filter and the metallic foil; joining the metallic foil and the metallic safety vent by welding through the aperture in the metallic filter, whereby a closure assembly is obtained; producing an electrode unit of a positive electrode and a negative electrode wound around with a separator interposed therebetween; accommodating the electrode unit and a liquid electrolyte in a metallic case with a bottom and attaching the closure assembly to the case; and crimping an end edge of the case with a resin outer gasket interposed therebetween to seal the case.

### EXAMPLES

Specific examples of the embodiment of the invention will be described below with reference to the drawings that show a cylindrical lithium ion battery, with which the effects of the invention are most evident.

FIG. 1 is a schematic longitudinal cross-sectional view of a cylindrical lithium ion battery according to one embodiment of the invention. The battery includes a cylindrical electrode unit 4 that consists of a positive electrode 1 and a negative electrode 2 coiled around with a 25 μm thick separator 3 interposed therebetween. The positive electrode 1 is made of an aluminum foil collector and a positive electrode mixture deposited thereon, and the negative electrode 2 is made of a copper foil collector and a negative electrode mixture deposited thereon. A collector lead 5 of the positive electrode is connected to the aluminum foil collector by laser welding, and a collector lead 6 of the negative electrode is connected to the copper foil collector by resistance welding. The electrode unit 4 is encased in a metallic case 7 with a bottom. The collector lead 6 of the negative electrode is electrically connected to the bottom of the case 7 by resistance welding. The collector lead 5 of the positive electrode is electrically connected to the metallic filter 9 of the closure assembly 8 through the open end of the case 7 by laser welding. Non-aqueous liquid electrolyte is poured into the case 7 from its open end. A groove is formed at the open end of the case 7 to provide a seat, on which a resin outer gasket 15 and the closure assembly 8 are set, with the collector lead 5 being bent, and the entire circumference of the open end edge of the case 7 is crimped to provide a seal.

Examples of the positive electrode active material include a complex oxide such as lithium cobalt oxide, lithium nickel oxide, and lithium manganese oxide, or modified complex oxides. The modified complex oxide may contain aluminum or magnesium element, and/or cobalt, nickel, or manganese element.

The positive electrode active material is mixed with a conductor agent, which is, for example, graphite, carbon black, or metallic powder that is stable in the positive potential, and a binder, which is, for example, polyvinylidene fluoride (PVDF) or polytetrafluoroethylene (PTFE) that is stable in the positive potential into paste and coated on the current collector made of a foil or punched sheet of aluminum. The active material paste is not applied at one end of the current collector, where the collector lead 5 made of aluminum is attached by welding. The positive electrode 1 is thus produced.

Examples of the negative electrode active material include natural graphite, artificial graphite, aluminum or alloys chiefly composed of these, a metal oxide such as tin oxide, and a metal nitride.

The negative electrode active material is mixed with a conductor agent, which is, for example, graphite, carbon black, or metallic powder that is stable in the negative potential, and a binder, which is, for example, styrene butadiene rubber (SBR) or carboxy methyl cellulose (CMC) that is stable in the negative potential into paste and coated on the current collector made of a foil or punched sheet of copper. The active material paste is not applied at one end of the current collector, where the collector lead 6 made of copper or nickel is attached by welding. The negative electrode 2 is thus produced.

The positive and negative electrodes 1 and 2 are wound around with the separator 3 which is a microporous film or non-woven cloth of polyolefin interposed therebetween, with the collector leads 5 and 6 extending to opposite directions. The electrode unit 4 in the present invention is thus produced. This is then inserted in the metallic case 7 with a bottom made of iron, nickel, or stainless steel, and the collector lead 6 of the negative electrode is electrically connected to the bottom of the case 7 by welding.

The electrolyte is a non-aqueous liquid electrolyte, or an electrolyte gel, which is made by impregnating a polymer material with a non-aqueous liquid electrolyte. The non-aqueous liquid electrolyte is composed of a solute and a non-aqueous solvent. Examples of the solute include a lithium salt such as lithium hexafluorophosphate (LiPF₆) and lithium tetrafluoroborate (LiBF₄). Examples of the non-aqueous solvent include, but no limited to, a cyclic carbonate such as ethylene carbonate and propylene carbonate, or a chain carbonate such as dimethyl carbonate, diethyl carbonate, and ethyl methyl carbonate. One of these may be used alone, or in combination with another. Examples of additives include vinylene carbonate, cyclohexyl benzen, and diphenyl ether.

The closure assembly 8 includes a metallic filter 9 and a metallic foil 10 inside the filter, both being made of, for example, aluminum and welded together. A resin inner gasket 11 is placed upon the metallic foil 10. Examples of the material of the inner gasket include crosslinked polypropylene (PP), polybutylene terephthalate (PBT), polyphenylene sulfide (PPS), perfluoro alcoxyalkane (PFA), and polytetrafluoroethylene (PTFE) resins. A metallic safety vent 12 is made of aluminum, and a metallic cap 13 is made of any of iron, nickel, copper, aluminum or a clad material of these. The metallic safety vent 12 and the metallic cap 13 are welded together, and placed upon the resin inner gasket 11. All of these are set in the metallic filter 9, and its end edge is crimped to provide a seal. In the present invention, these metallic parts should preferably be joined together by laser welding, resistance welding, or ultrasonic welding.

After all these process steps, the collector lead 5 of the positive electrode extending through the open end of the case 7 is welded to the closure assembly 8, which is coupled onto the case 7, and with the inner gasket 11 inserted therebetween, the open end edge of the case-7 is crimped, to complete the cylindrical lithium ion battery.

While the above described process steps are for producing a cylindrical lithium ion battery, other types of batteries such as prismatic lithium ion batteries and nickel metal hydride or nickel cadmium rechargeable batteries, may also take advantage of the features of the invention described above, by making use of commonly known battery materials.

### Example 1

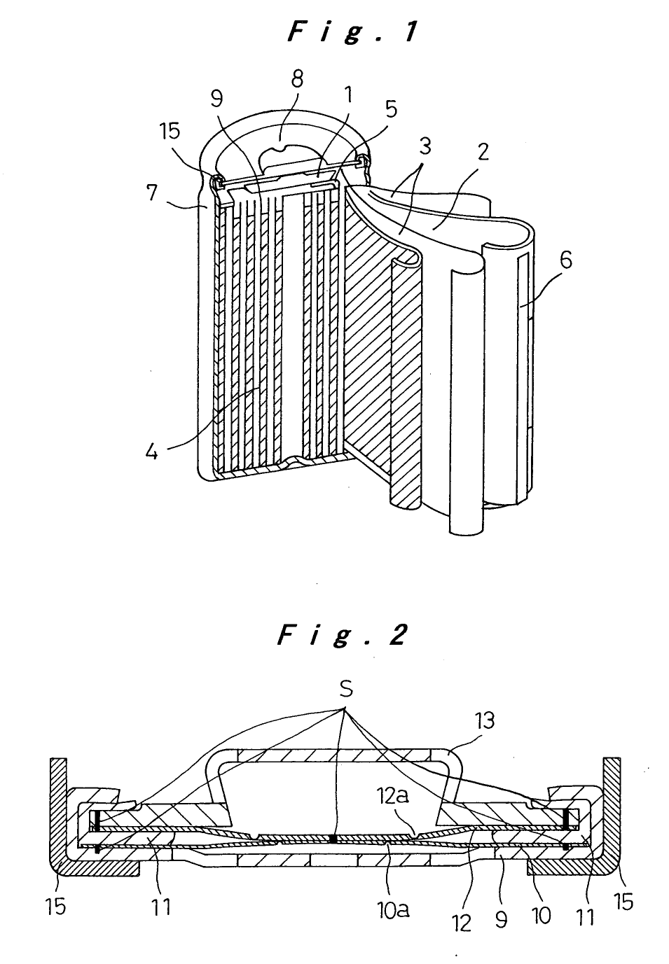

FIG. 2 shows the closure assembly in the sealed rechargeable battery of the invention. The closure assembly 8 of FIG. 2 is fabricated as follows: Dish-like metallic filters 9 with a plurality of apertures are produced from aluminum sheet by press-forming. Aluminum discs of 0.15 mm thickness are punched out, and circular thin portions 10a are created in the center of the discs by imprinting, to produce metallic foils 10. Inner gaskets 11 with predetermined dimensions are produced from polybutylene terephthalate (PBT) by injection molding. Aluminum discs of 0.15 mm thickness are punched out, and C-shaped thin portions 12a are created in the center of the discs by imprinting, to produce metallic safety vents 12. Metallic caps 13 are produced by press-forming and nickel-plating iron sheet to a thickness of about 3 μm. These parts that will make up the closure assembly 8 are then assembled as follows: The metallic foil 10 is placed on the seat of the metallic filter 9, and laser-welded at eight circumferentially equally spaced locations S in the periphery. The resin inner gasket 11 is placed upon the welded metallic foil 10. The metallic safety vent 12 is laser-welded to the metallic cap 13 at eight circumferentially equally spaced locations S in the periphery, and these weld-joined metallic cap 13 and metallic safety vent 12 are placed upon the resin inner gasket 11. The end edge of the metallic filter 9 is crimped, to unite all these parts airtightly. The metallic foil 10 is laser-welded to the metallic safety vent 12 at one location S in the center, through the aperture in the metallic filter 9. A resin outer gasket 15, which is produced from PBT by injection molding, is coupled to the thus assembled closure assembly 8 shown in FIG. 2.

The positive electrode 1 is produced as follows: The positive electrode mixture is first prepared, which contains 85 weight parts of lithium cobalt oxide powder, 10 weight parts of carbon powder as a conductive agent, and 5 weight parts of polyvinylidene fluoride (PVDF) in N-methyl-2-pyrrolidone (NMP) as a binder. The mixture paste is coated on the collector made of a 15 μm thick aluminum foil and dried, which is then rolled to produce positive electrodes 1 with a thickness of 100 μm.

The negative electrode 2 is produced as follows: The negative electrode mixture is first prepared, which contains 95 weight parts of artificial graphite powder, and 5 weight parts of PVDF in NMP as a binder. The mixture paste is coated on the collector made of a 10 μm thick copper foil and dried, which is then rolled to produce negative electrodes 2 with a thickness of 110 μm.

The non-aqueous liquid electrolyte is produced by mixing ethylene carbonate and ethyl methyl carbonate at a volume ratio of 1:1 to serve as a solvent, and dissolving LiPF₆ in this non-aqueous solvent at a concentration of 1 mol/L. The non-aqueous liquid electrolyte is used in a quantity of 15 ml.

Example 1 of the sealed rechargeable battery is obtained through the process steps described above. The battery is a 25 mm diameter, 65 mm high cylindrical lithium ion battery with a designed capacity of 2000 mAh.

### Example 2

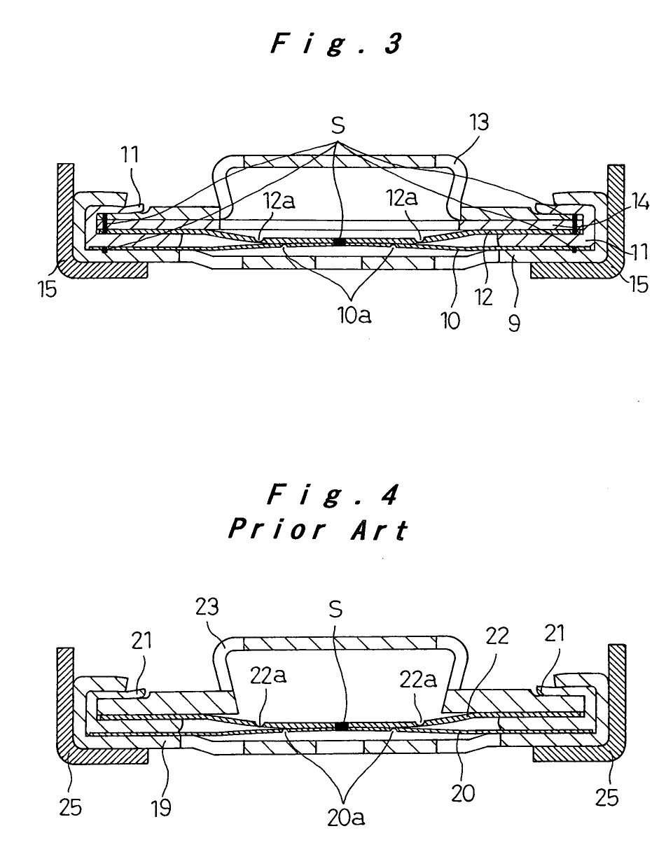

FIG. 3 shows another closure assembly 8 of the sealed rechargeable battery of the invention. The battery itself is produced similarly to Example 1. The closure assembly 8 includes a disc-like metallic spacer 14 as shown in FIG. 3, made by press-forming a nickel-plating stainless steel sheet to a thickness of 3 μm. The metallic spacer 14 is joined to the metallic cap 13 at eight circumferentially equally spaced weld joints S in the periphery by resistance welding. These joined parts are laser-welded to the metallic safety vent 12 at eight circumferentially equally spaced locations S in the periphery. These joined parts are then inserted onto the resin inner gasket 11 such that the metallic safety vent 12 is in contact with the upper surface of the gasket. Apart from the above difference in the closure assembly, Example 2 of the battery is the same as Example 1.

### Comparative Example 1

A metallic foil, a polypropylene inner gasket, and a metallic safety vent were inserted into a metallic filter, and the metallic foil and the metallic safety vent were joined at one weld joint S in the center by laser welding. Then a metallic cap was inserted, and the end edge of the metallic filter was crimped to provide a seal. An outer gasket was made from polypropylene by injection molding. Apart from the above difference in the closure assembly, Comparative Example 1 of the battery (not shown) was produced through the similar process steps as those of Example 1.

### Comparative Example 2

A metallic foil and a polypropylene inner gasket were inserted into a metallic filter. A metallic safety vent was inserted, and the metallic foil and the metallic safety vent were joined at one weld joint S in the center by laser welding. Then a metallic spacer and a metallic cap were inserted, and the end edge of the metallic filter was crimped to provide a seal and to make these parts into one piece. An outer gasket made from polypropylene by injection molding was attached to the joined parts. Apart from the above difference in the closure assembly, Comparative Example 2 of the battery (not shown) was produced through the similar process steps as those of Example 1.

The closure assemblies of the batteries of Examples and Comparative Examples were compared and evaluated.

(Free Fall Test from the Height of 2 m)

Twenty-five pieces each of the batteries of the present invention and Comparative Examples were prepared, and resistance at AC 1 kHz between the metallic filter 9 and the metallic cap 13 in the closure assemblies 8 was measured. The batteries then underwent three cycles of charging to 4.2V and discharging to 3.0V at a constant current of 1250 mA. After the batteries were dropped five times from the height of 2 m, they were disassembled to remove the closure assembly, and the resistance at AC 1 kHz between the metallic filter 9 and the metallic cap 13 was measured again. Table 1 shows the resistance values of the closure assemblies of the batteries of the present invention and Comparative Examples.

(Heat Cycle Test)

Twenty-five pieces each of the batteries of the present invention and Comparative Examples were prepared, and resistance at AC 1 kHz between the metallic filter 9 and the metallic cap 13 in the closure assemblies 8 was measured. The batteries then underwent three cycles of charging to 4.2V and discharging to 3.0V at a constant current of 1250 mA. After the batteries were stored in a heat cycle tank for twenty cycles of two hours at −40° C., thirty minutes of temperature rise, two hours at 80° C., and thirty minutes of temperature fall, they were disassembled to remove the closure assembly, and the resistance at AC 1 kHz between the metallic filter 9 and the metallic cap 13 was measured again. Table 2 shows the resistance values of the closure assemblies of the batteries of the present invention and Comparative Examples.

(Pulse Discharge Test)

One piece each of the batteries of the present invention and Comparative Examples were prepared, and resistance at AC 1 kHz between the metallic filter 9 and the metallic cap 13 in the closure assemblies 8 was measured. The batteries then underwent three cycles of charging to 4.2V and discharging to 3.0V at a constant current of 1250 mA. After that, the batteries were pulse discharged at 40 A for twenty seconds followed by five seconds interval, and the temperature of the closure assembly during discharge was measured. The batteries were then disassembled to remove the closure assembly, and the resistance at AC lkHz between the metallic filter 9 and the metallic cap 13 was measured again. Table 3 shows the temperatures and resistance values of the closure assemblies of the batteries of the present invention and Comparative Examples.

TABLE 1

| Example 1 | | | Example 2 | | | Comparative Example 1 | | | Comparative Example 2 | | |
|---|---|---|---|---|---|---|---|---|---|---|---|
| | Initial | After the | | Initial | After the | | Initial | After the | | Initial | After the |
| Battery | Value | Test | Battery | Value | Test | Battery | Value | Test | Battery | Value | Test |
| No. | (mΩ) | (mΩ) | No. | (mΩ) | (mΩ) | No. | (mΩ) | (mΩ) | No. | (mΩ) | (mΩ) |
| A1 | 0.37 | 0.41 | B1 | 0.41 | 0.41 | C1 | 0.43 | 0.98 | D1 | 0.45 | 0.73 |
| A2 | 0.36 | 0.40 | B2 | 0.40 | 0.41 | C2 | 0.43 | 0.98 | D2 | 0.42 | 0.77 |
| A3 | 0.38 | 0.39 | B3 | 0.41 | 0.42 | C3 | 0.44 | 0.99 | D3 | 0.43 | 0.77 |
| A4 | 0.38 | 0.40 | B4 | 0.39 | 0.40 | C4 | 0.45 | 1.00 | D4 | 0.42 | 0.74 |
| A5 | 0.38 | 0.40 | B5 | 0.41 | 0.41 | C5 | 0.42 | 1.05 | D5 | 0.45 | 0.74 |
| A6 | 0.37 | 0.41 | B6 | 0.39 | 0.39 | C6 | 0.43 | 1.05 | D6 | 0.42 | 0.75 |
| A7 | 0.38 | 0.41 | B7 | 0.39 | 0.39 | C7 | 0.42 | 1.02 | D7 | 0.44 | 0.72 |
| A8 | 0.36 | 0.40 | B8 | 0.40 | 0.40 | C8 | 0.45 | 1.06 | D8 | 0.43 | 0.73 |
| A9 | 0.37 | 0.39 | B9 | 0.40 | 0.40 | C9 | 0.42 | 0.99 | D9 | 0.44 | 0.73 |
| A10 | 0.38 | 0.40 | B10 | 0.40 | 0.41 | C10 | 0.44 | 1.02 | D10 | 0.42 | 0.74 |
| A11 | 0.38 | 0.39 | B11 | 0.40 | 0.40 | C11 | 0.43 | 1.05 | D11 | 0.44 | 0.76 |
| A12 | 0.38 | 0.40 | B12 | 0.41 | 0.41 | C12 | 0.44 | 1.06 | D12 | 0.41 | 0.77 |
| A13 | 0.37 | 040 | B13 | 0.41 | 0.41 | C13 | 0.44 | 1.06 | D13 | 0.44 | 0.78 |
| A14 | 0.37 | 0.39 | B14 | 0.40 | 0.40 | C14 | 0.44 | 1.00 | D14 | 0.43 | 0.77 |
| A15 | 0.38 | 0.38 | B15 | 0.40 | 0.40 | C15 | 0.43 | 1.07 | D15 | 0.43 | 0.78 |
| A16 | 0.38 | 0.38 | B16 | 0.39 | 0.40 | C16 | 0.44 | 1.01 | D16 | 0.44 | 0.76 |
| A17 | 0.38 | 0.40 | B17 | 0.39 | 0.40 | C17 | 0.45 | 1.07 | D17 | 0.44 | 0.75 |
| A18 | 0.38 | 0.40 | B18 | 0.39 | 0.40 | C18 | 0.44 | 0.99 | D18 | 0.43 | 0.77 |
| A19 | 0.37 | 0.38 | B19 | 0.40 | 0.41 | C19 | 0.43 | 1.05 | D19 | 0.44 | 0.75 |
| A20 | 0.37 | 0.38 | B20 | 0.40 | 0.41 | C20 | 0.45 | 1.06 | D20 | 0.45 | 0.76 |
| A21 | 0.38 | 0.40 | B21 | 0.39 | 0.41 | C21 | 0.45 | 1.07 | D21 | 0.44 | 0.77 |
| A22 | 0.37 | 0.40 | B22 | 0.39 | 0.42 | C22 | 0.42 | 1.07 | D22 | 0.43 | 0.78 |
| A23 | 0.38 | 0.40 | B23 | 0.39 | 0.42 | C23 | 0.44 | 1.06 | D23 | 0.45 | 0.78 |
| A24 | 0.38 | 0.41 | B24 | 0.41 | 0.42 | C24 | 0.41 | 1.07 | D24 | 0.45 | 0.79 |
| A25 | 0.38 | 0.40 | B25 | 0.41 | 0.42 | C25 | 0.44 | 1.07 | D25 | 0.44 | 0.75 |
| Average | 0.38 | 0.40 | Average | 0.40 | 0.41 | Average | 0.44 | 1.04 | Average | 0.44 | 0.76 |

TABLE 2

| Example 1 | | | Example 2 | | | Comparative Example 1 | | | Comparative Example 2 | | |
|---|---|---|---|---|---|---|---|---|---|---|---|
| | Initial | After the | | Initial | After the | | Initial | After the | | Initial | After the |
| Battery | Value | Cycle Test | Battery | Value | Cycle Test | Battery | Value | Cycle Test | Battery | Value | Cycle Test |
| No. | (mΩ) | (mΩ) | No. | (mΩ) | (mΩ) | No. | (mΩ) | (mΩ) | No. | (mΩ) | (mΩ) |
| A26 | 0.36 | 0.41 | B26 | 0.39 | 0.39 | C26 | 0.50 | 1.12 | D26 | 0.43 | 0.73 |
| A27 | 0.37 | 0.40 | B27 | 0.39 | 0.39 | C27 | 0.45 | 1.15 | D27 | 0.44 | 0.73 |
| A28 | 0.38 | 0.39 | B28 | 0.39 | 0.40 | C28 | 0.46 | 1.05 | D28 | 0.45 | 0.74 |
| A29 | 0.38 | 0.40 | B29 | 0.38 | 0.40 | C29 | 0.51 | 1.08 | D29 | 0.44 | 0.72 |
| A30 | 0.38 | 0.40 | B30 | 0.38 | 0.41 | C30 | 0.45 | 1.10 | D30 | 0.43 | 0.72 |
| A31 | 0.37 | 0.41 | B31 | 0.38 | 0.39 | C31 | 0.48 | 1.02 | D31 | 0.45 | 0.76 |
| A32 | 0.37 | 0.41 | B32 | 0.39 | 0.39 | C32 | 0.48 | 1.08 | D32 | 0.45 | 0.71 |
| A33 | 0.38 | 0.40 | B33 | 0.38 | 0.41 | C33 | 0.44 | 1.15 | D33 | 0.44 | 0.70 |
| A34 | 0.38 | 0.39 | B34 | 0.40 | 0.41 | C34 | 0.49 | 1.16 | D34 | 0.44 | 0.73 |
| A35 | 0.38 | 0.40 | B35 | 0.40 | 0.40 | C35 | 0.44 | 1.12 | D35 | 0.42 | 0.71 |
| A36 | 0.37 | 0.39 | B36 | 0.40 | 0.40 | C36 | 0.47 | 1.15 | D36 | 0.44 | 0.70 |
| A37 | 0.36 | 0.40 | B37 | 0.41 | 0.40 | C37 | 0.47 | 1.16 | D37 | 0.41 | 0.71 |
| A38 | 0.37 | 0.40 | B38 | 0.41 | 0.40 | C38 | 0.51 | 1.16 | D38 | 0.44 | 0.71 |
| A39 | 0.37 | 0.39 | B39 | 0.40 | 0.40 | C39 | 0.49 | 1.09 | D39 | 0.43 | 0.72 |
| A40 | 0.38 | 0.38 | B40 | 0.40 | 0.41 | C40 | 0.49 | 1.09 | D40 | 0.43 | 0.73 |
| A41 | 0.38 | 0.38 | B41 | 0.40 | 0.39 | C41 | 0.50 | 1.11 | D41 | 0.44 | 0.73 |
| A42 | 0.38 | 0.40 | B42 | 0.40 | 0.39 | C42 | 0.45 | 1.12 | D42 | 0.42 | 0.74 |
| A43 | 0.37 | 0.40 | B43 | 0.39 | 0.40 | C43 | 0.44 | 1.15 | D43 | 0.44 | 0.72 |
| A44 | 0.36 | 0.38 | B44 | 0.39 | 0.40 | C44 | 0.49 | 1.14 | D44 | 0.42 | 0.73 |
| A45 | 0.37 | 0.38 | B45 | 0.39 | 0.41 | C45 | 0.45 | 1.14 | D45 | 0.44 | 0.77 |
| A46 | 0.38 | 0.40 | B46 | 0.38 | 0.39 | C46 | 0.45 | 1.13 | D46 | 0.41 | 0.77 |
| A47 | 0.38 | 0.40 | B47 | 0.40 | 0.42 | C47 | 0.47 | 1.15 | D47 | 0.44 | 0.73 |
| A48 | 0.37 | 0.40 | B48 | 0.40 | 0.42 | C48 | 0.44 | 1.16 | D48 | 0.43 | 0.78 |
| A49 | 0.38 | 0.41 | B49 | 0.41 | 0.42 | C49 | 0.44 | 1.07 | D49 | 0.43 | 0.73 |
| A50 | 0.38 | 0.40 | B50 | 0.41 | 0.42 | C50 | 0.44 | 1.07 | D50 | 0.44 | 0.75 |
| Average | 0.37 | 0.40 | Average | 0.39 | 0.40 | Average | 0.47 | 1.12 | Average | 0.43 | 0.73 |

TABLE 3

| | | After Pulse | |
|---|---|---|---|
| | Initial Value | Discharge | Closure Assembly |
| | Resistance(mΩ) | Resistance(mΩ) | Temperature(° C.) |
| Example 1 | 0.37 | 0.37 | 70 |
| Example 2 | 0.39 | 0.39 | 73 |
| Comparative | 0.43 | >1000 | 110 |
| Example 1 | | | |
| Comparative | 0.47 | >1000 | 125 |
| Example 2 | | | |

Table 1 shows the following: The average initial resistance in the closure assembly of Example 1 of the invention was 0.38 mΩ, while the average resistance after the free fall test was 0.40 mΩ. The average initial resistance in the closure assembly of Example 2 was 0.40 mΩ, while the average resistance after the free fall test was 0.41 Ω. In either case, there was almost no increase in the resistance. On the other hand, the average resistance in the closure assemblies of Comparative Examples 1 and 2 was increased from the initial value after the free fall test, i.e., from 0.44 mΩ to 1.04 mΩ in Comparative Example 1, and from 0.40 mΩ to 0.76 mΩ in Comparative Example 2. Visual observation of the disassembled closure assemblies of Comparative Examples 1 and 2 revealed that the resistance was small at weld joints. Contact resistance existed in many parts in both batteries, and therefore it was assumed that the closure assembly was deformed by the impact of the free fall and some parts made contact with each other, resulting in the increased contact resistance. On the other hand, the closure assemblies of Examples 1 and 2 of the invention remained intact even after the free fall test because the various parts were rigidly joined together by welding, and hence no increase in resistance.

Table 2 shows the following: The average initial resistance in the closure assembly of Example 1 of the invention was 0.37 mΩ, while the average resistance after the heat cycle test was 0.40 mΩ. The average initial resistance in the closure assembly of Example 2 was 0.39 mΩ, while the average resistance after the heat cycle test was 0.40 mΩ. In either case, there was almost no increase in the resistance. On the other hand, the average resistance in the closure assemblies of Comparative Examples 1 and 2 was increased from the initial value after the heat cycle test, i.e., from 0.47 mΩ to 1.12 mΩ in Comparative Example 1, and from 0.43 mΩ to 0.73 mΩ in Comparative Example 2. It turned out that the resistance reduced as low as the initial value when the end edge of the metallic filter of the closure assemblies of Comparative Examples 1 and 2 was crimped again. Therefore, it was assumed that the contact resistance between various parts had increased because the resin inner gasket lost its resiliency through the heat cycle test. On the other hand, the closure assemblies of Examples 1 and 2 of the invention remain intact even if there is a decrease in the resiliency of resin parts because various parts were rigidly joined together by welding, and hence no increase in resistance. The resistance will not increase in the closure assembly of the battery of the invention even if some parts inside are deformed due to a free fall impact or shock, or even if the resiliency in the crimped parts is decreased after a long period of storage. Therefore the battery of the invention ensures stable high output performance with small internal resistance.

Table 3 shows the following: The average initial resistance in the closure assembly of Example 1 of the invention was 0.37 mΩ, while the average resistance after the pulse discharging was 0.37 mΩ. The average initial resistance in the closure assembly of Example 2 was 0.39 mΩ, while the average resistance after the pulse discharging was 0.39 mΩ. In either case, there was no change in the resistance. On the other hand, the average resistance in the closure assemblies of Comparative Examples 1 and 2 was increased from the initial value after the pulse discharging, i.e., from 0.43 mΩ to more than 1 kΩ in Comparative Example 1, and from 0.47 mΩ to more than 1 kΩ in Comparative Example 2. Visual observation of the closure assemblies of Comparative Examples 1 and 2 revealed that the crimp-sealed parts were loosened due to softened inner gasket, resulting in the increase in contact resistance. Therefore, it was assumed that the high-current discharge had caused heat generation in the contact parts, which softened the resin inner gasket and decreased the crimp strength, resulting in the increase in resistance. On the other hand, with the closure assemblies of Examples 1 and 2 of the invention, there will be no increase in resistance even if there is a decrease in the resiliency of resin inner gasket and in the crimp strength because various parts were rigidly joined together by welding. Furthermore, the PBT inner gasket used in Examples 1 and 2 of the invention has a high thermal deformation temperature and does not soften in case of temperature rise, and will not cause a decrease in the crimp strength. Since the resistance will not increase in the closure assembly of the battery of the invention even if some parts inside are deformed due to a free fall impact or shock, or even if the resiliency in the crimped parts is decreased after a long period of storage, the battery of the invention is capable of high-current discharge and stable high output with small internal resistance.

With the use of the above described closure assembly of the invention, a sealed rechargeable battery with low internal resistance suitable for high power output is provided. The closure assembly is also used for the driving power source battery of a notebook PC, mobile phone, digital still camera, and the like. The closure assembly is also applicable for use in the batteries of electric tools or electric vehicles that require high-current charge and discharge.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

What is claimed is:

1. A sealed rechargeable battery comprising an electrode unit and a liquid electrolyte encased in a metallic case with a bottom, and a closure assembly attached to the case by crimping the case end with a resin outer gasket interposed therebetween, the electrode unit including a positive electrode and a negative electrode wound around with a separator interposed therebetween, wherein metallic parts that make up the closure assembly are all joined together by welding.

2. The sealed rechargeable battery according to claim 1, wherein:
the closure assembly includes a metallic filter which accommodates a safety mechanism consisting of a metallic safety vent and a metallic foil, the resin inner gasket, and a metallic cap; and
the metallic filter and all metallic parts accommodated in the metallic filter are joined together by welding.

3. The sealed rechargeable battery according to claim 2, wherein:
the metallic cap and the metallic safety vent, and the metallic filter and the metallic-foil, are respectively joined at four or more circumferentially equally located welds in the periphery; and
the metallic safety vent and the metallic foil are welded together at the center.

4. The sealed rechargeable battery according to claim 2, wherein
a resistance between the metallic cap and the metallic filter is in the range of 0.01 to 0.5 mΩ.

5. The sealed rechargeable battery according to claim 2, wherein
a disc-like metallic spacer is interposed between the metallic safety vent and the metallic cap inside the metallic filter.

6. A method for producing a sealed rechargeable battery, comprising:
joining a metallic cap and a metallic safety vent by welding;
joining a metallic filter having an aperture and a metallic foil by welding;
crimping an end edge of the metallic filter after placing a resin inner gasket and the joined metallic cap and the metallic safety vent onto the joined metallic filter and the metallic foil;
joining the metallic foil and the metallic safety vent by welding through the aperture in the metallic filter, whereby a closure assembly is obtained;
producing an electrode unit of a positive electrode and a negative electrode wound around with a separator interposed therebetween;
accommodating the electrode unit and a liquid electrolyte in a metallic case with a bottom and attaching the closure assembly to the case; and
crimping an end edge of the case with a resin outer gasket interposed therebetween to seal the case.
